(19) United States
(12) Patent Application Publication
(10) Pub. No.: US 2015/0163864 A1
(43) Pub. Date: Jun. 11, 2015

(54) INDUCTIVE COOKING SYSTEM

(71) Applicant: Access Business Group International LLC, Ada, MI (US)

(72) Inventors: David W. Baarman, Fennville, MI (US); Joshua B. Taylor, Rockford, MI (US); Kaitlyn J. Turner, Kentwood, MI (US)

(73) Assignee: Acess Business Group International LLC, Ada, MI (US)

(21) Appl. No.: 14/370,356

(22) PCT Filed: Jan. 7, 2013
(86) PCT No.: PCT/US13/20473

§ 371 Date: Jul. 2, 2014

Related U.S. Application Data
(60) Provisional application No. 61/584,281, filed on Jan. 8, 2012.

(51) Int. Cl. H05B 6/12

(52) U.S. Cl. CPC H05B 6/1209

(57) ABSTRACT

The present invention provides a wireless power supply system in which a resonator may extend the range over which an inductive power supply may adequately supply wireless power to inductive cookware. The wireless power supply system may include an inductive cooking power supply that transmits power using an electromagnetic field, an inductive cookware that heats in response to presence of the electromagnetic field, and a resonator.

### BACKGROUND

The present invention relates to wireless power transfer, and more particularly to systems for transferring power from an inductive power supply.

The use of wireless power supply systems continues to grow. Common wireless power supply systems use electromagnetic fields to wirelessly transfer power from a wireless power supply or inductive power supply to a remote device, such as an inductive cooking utensil, a wirelessly powered light, a cell phone, a smart phone, a media player or other electronic device. There are a number of different wireless power supply systems. For example, many conventional systems use a secondary coil in the remote device to inductively couple with a primary coil in the wireless power supply. Other conventional systems, commonly found in a cooking area, use a heating element in the remote device to inductively couple with the primary coil in the wireless power supply.

When the remote device is placed within sufficient proximity to the wireless power supply, the electromagnetic field induces power within the secondary coil or generates eddy currents in the heating element. Power within the secondary coil can be used by the remote device, for example, to power or charge, or both, the remote device. Eddy currents within the heating element may generate heat that can be used for cooking. Regardless of whether the remote device includes a secondary coil or a heating element, conventional wireless power supply systems typically provide improved performance when the primary coil is relatively close to the secondary coil or heating element.

In many wireless power supply systems found in cooking areas, for example, the wireless power supply is disposed beneath a surface, such as a counter top, table, or other structure, in order to hide the wireless power supply from view. However, the thickness of a table or other structure can affect the proximity at which the remote device can be placed with respect to the wireless power supply. If the table is too thick, coupling between the wireless power supply and the remote device may suffer resulting in reduced performance over a similar system but otherwise configured for closer proximity coupling. To address this performance loss concern, the table thickness can be reduced through a variety of techniques (e.g., machining or cutting) and the wireless power supply can be mounted to the reduced thickness area of the table. These techniques often times involve the use of tools that may not be available or within the skill level of a typical user. And, reducing the thickness of the table is a permanent change that can affect the integrity of the table.

### SUMMARY OF THE INVENTION

The present invention provides a wireless power supply system in which a resonator may extend the range over which an inductive power supply may adequately supply wireless power to inductive cookware. The wireless power supply system may include an inductive power supply that transmits power using an electromagnetic field, an inductive cookware that heats in response to presence of the electromagnetic field, and a resonator.

In one embodiment, the wireless power supply system may include a device comprising a pad and a resonator. The pad may be adapted to be removably placed between a device and a primary of an inductive power supply, and the resonator may couple to the pad. The resonator may be adapted to inductively transfer energy from said primary to the device, whereby the resonator extends the range over which the device receives wireless power from the inductive power supply. The device may be an inductive cookware including metal adapted to heat in the presence of an electromagnetic field generated from the inductive power supply.

In another aspect, the wireless power supply system may be an inductive cooking system for heating metal of an inductive cookware. The system may include an inductive cooking power supply and a resonator. The inductive cooking power supply may comprise a primary, and may be adapted to produce an electromagnetic field. The resonator may be adapted to inductively transfer energy from the primary to the metal such that the metal of the inductive cookware heats in response to the electromagnetic field being produced by the inductive cooking power supply.

In one embodiment, the inductive cooking system may include a pad adapted to be placed between the inductive cooking power supply and the inductive cookware, where the pad may be coupled to the resonator.

In some embodiments, the pad may be a portable trivet positioned on a surface of a countertop, where the inductive cooking power supply may be positioned on an opposite surface of the countertop. Alternatively, rather than being portable, the pad may be affixed to the surface of the countertop.

In another embodiment, the pad may include an insulator adapted to inhibit heat transfer from the inductive cookware through the pad. The resonator may also be disposed within the pad.

In yet another embodiment, the resonator may be coupled to the inductive cookware such that it is disposed on or in the inductive cookware.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a representative view of a resonant wireless power supply system including a wireless power supply having a primary coil and a primary resonator and a wireless receiver having a secondary resonator and a secondary coil;

FIG. 2a is a representative view of an inductive cooking supply having a primary coil;

FIG. 2b is a perspective view of an inductive cooking system including the inductive cooking power supply and an inductive cookware;

FIG. 2c is an exploded view of an inductive cookware having circuitry adapted to monitor a temperature of the inductive cookware and communicate information to an inductive cooking power supply;

FIG. 3 is a representative view of an inductive cooking power supply and a resonator disposed on or in a trivet according to a first embodiment of the wireless power supply system;

FIG. 4 is a representative view of the first embodiment of the wireless power supply system, including a trivet having a resonator and being positioned beneath an inductive cookware;

FIG. 5 is a representative view of a second embodiment of the wireless power supply system, including an inductive cookware having a resonator;

FIG. 6a is a representative view of the inductive cookware of the first embodiment of the wireless power supply system;

FIG. 6b is a representative view of the inductive cookware of the second embodiment of the wireless power supply system;

FIG. 6c is a representative view of an alternative inductive cookware of the second embodiment of the wireless power supply system;

FIG. 7a is a sectional view of the inductive cookware of the first embodiment of the wireless power supply system;

FIG. 7b is a sectional view of the inductive cookware of the first embodiment of the wireless power supply system;

FIG. 7c is a sectional view of the alternative inductive cookware of the second embodiment of the wireless power supply system;

FIG. 8 is a representative view of a third embodiment of the wireless power supply system having temperature feedback circuitry;

FIG. 9 illustrates feedback pulses of the temperature feedback circuitry of the third embodiment of the wireless power supply system;

FIG. 10 is a representative view of an inductive cookware of the third embodiment of the wireless power supply system;

FIG. 11 is a representative view of an inductive power supply, a portable resonator, and a portable device according to a fourth embodiment of the wireless power supply system; and

FIG. 12 is a representative view of the fourth embodiment of the wireless power supply system having a power indicator.

FIG. 13 is a perspective view of one embodiment of the present invention where a trivet includes temperature feedback circuitry.

FIG. 14 is a perspective view of one embodiment of the present invention where a trivet includes temperature feedback circuitry.

FIG. 15 is a perspective view of one embodiment of the present invention where a trivet can be placed inside a container, such as a pot, pan, dish, or other item.

FIG. 16 is a perspective view of one embodiment of the present invention showing a trivet within a container.

FIG. 17 is a perspective view of one embodiment of the present invention in which an inductive power supply can be placed underneath a table.

FIG. 18 is a perspective view of one embodiment of the present invention in which an inductive power supply can be located above a table.

FIG. 19 is a perspective view of an inductive power receiver according to one embodiment of the present invention, where energy received by the inductive power receiver is used to power a light.

FIG. 20 is a perspective view of an inductive power receiver according to one embodiment of the present invention, where a heating element is used to warm napkins or towels.

FIG. 21 is a perspective view of a wireless power supply system according to one embodiment of the present invention, where the inductive power receiver can power a light using wirelessly received energy.

FIG. 22 is a sectional view of an inductive cookware according to one embodiment of the present invention, showing an embedded thermocouple inside the inductive cookware.

FIG. 23 is a sectional view of an inductive cookware according to one embodiment of the present invention, showing an embedded RTD temperature sensing element inside the inductive cookware.

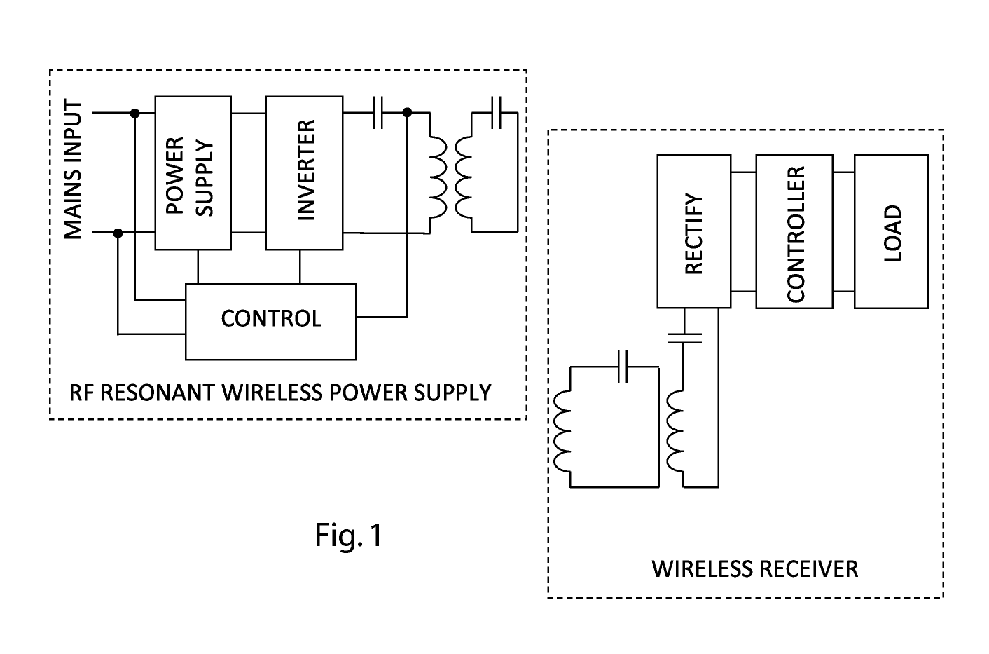

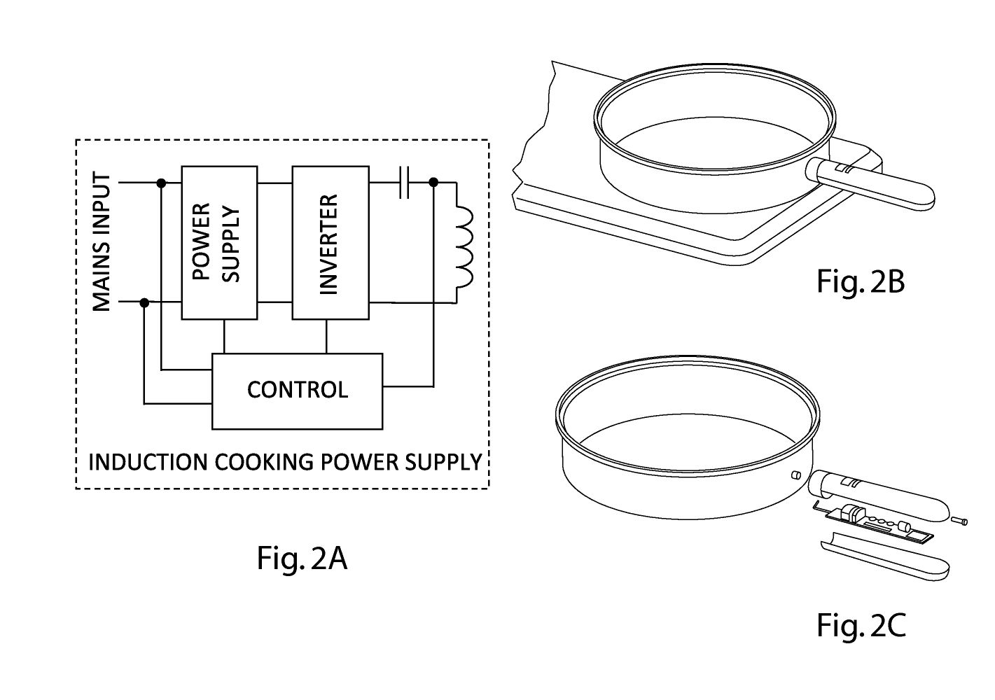

### DESCRIPTION OF THE CURRENT EMBODIMENT

A wireless power supply system may include an inductive cooking power supply that transmits power using an electromagnetic field, an inductive cookware that heats in response to presence of the electromagnetic field, and a resonator that may extend the range over which the inductive cooking power supply may adequately supply wireless power to the inductive cookware.

### I. First Embodiment

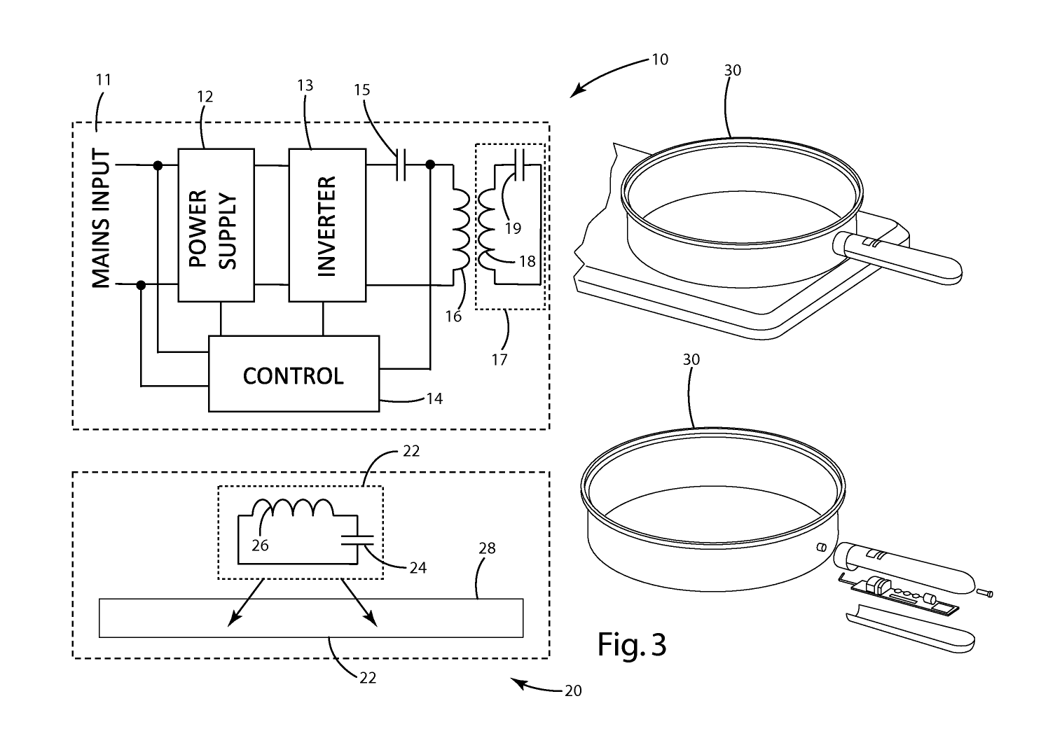

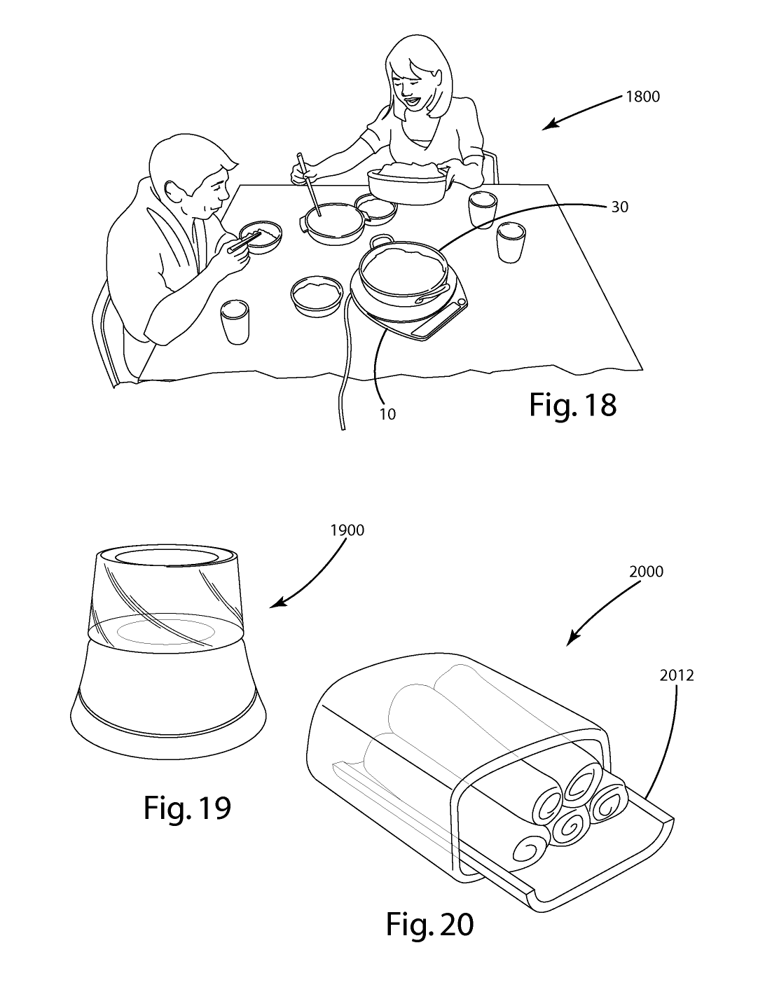

A wireless power supply system in accordance with a first embodiment of the present invention is shown in FIG. 3. The wireless power supply system includes an inductive cooking power supply 10 that transmits power using an electromagnetic field, an inductive cookware 30 that heats in response to presence of the electromagnetic field, and a pad or trivet 20 having a resonator 22 that transfers power to the inductive cookware 30 from the inductive cooking power supply 10. In this embodiment, the inductive cooking power supply 10 may be positioned in a variety of locations, including, for example, beneath a table as shown in the system 1700 of FIG. 17. Alternatively, the inductive cooking power supply 10 may be positioned on top of the table as shown in the system 1800 of FIG. 18. In other embodiments, the inductive cooking power supply 10 may be disposed near a kitchen countertop, or any other location.

The inductive cooking power supply 10 includes a primary coil 16 adapted to generate an electromagnetic field and a controller 14 that controls inductive power transmission to the inductive cookware 30. The inductive cooking power supply 10 of the illustrated embodiment of FIG. 3 may be designed for supplying power over a specific range or distance, such a range over the X, Y, and Z axis directions. The inductive cooking power 10 may be any type of inductive wireless power supply capable of transmitting power via an electromagnetic field. For example, in one embodiment, the inductive cooking power supply 10 may change operating frequency depending on a number of characteristics, such as power transfer efficiency. The term coil, as used herein, includes any structure capable of generating an electromagnetic field, including, for example, one or more turns of conductive material.

The inductive cooking power supply 10 may also include a primary capacitor 15, a primary resonating circuit 17, an inverter 13, a power supply 12, and a mains input 11. The power supply 12, inverter 13, and controller 14 may include circuitry configured to supply power to the primary 16 and the primary resonating circuit 17 in order to generate an electromagnetic field and transfer power to the inductive cookware 30.

The power supply 12 receives power from the mains input 11, where the mains input 11 may be AC power, DC power, or any another suitable energy source. The power supply 12 may convert the power from the mains input 11 into energy useable by the inverter 13. For example, the power supply 11 may provide DC power to the inverter 13 at a rail voltage. In some embodiments, the controller 14 may control the rail voltage output from the power supply 11 to the inverter 13 in order to control power output of the inductive cooking power supply 10. The inverter 13 uses the energy from the power supply 12 to provide AC power to the primary coil 16 and primary capacitor 15 in order to generate an electromagnetic field. The AC power may have a frequency, amplitude, phase, duty cycle, or any combination thereof, which the controller 14 may adjust by varying the timing of switches within the inverter 13. Accordingly, with the capability to control rail voltage, duty cycle, amplitude, frequency, phase, or combinations thereof, the inductive cooking power supply 10 may control the amount of power transferred to the inductive cookware 30.

The primary capacitor 15 and primary coil 16 may be selected to operate at resonance in response to AC power being applied at a resonant frequency of the primary capacitor 15 and primary coil 16. The primary resonating circuit 17 includes a primary resonating coil 18 and a primary resonating capacitor 19 selected to operate at resonance. The primary resonating coil 18 and primary coil 16 may be formed of conductive material, such as Litz wire or PCB traces.

As mentioned above, the inductive cooking power supply 10 may transfer power wirelessly to the inductive cookware 30. In operation, the primary coil 16 and primary capacitor 15 may receive power from the inverter 13 and transfer that power to the primary resonating circuit 17 via inductive coupling between the primary coil 16 and the primary resonating coil 18 of the primary resonating circuit 17. The primary resonating circuit 17 may then generate an electromagnetic field capable of transferring power to the inductive cookware 30. The primary resonating circuit 17 may have a resonant frequency similar to that of the primary capacitor 15 and primary coil 16 for efficient coupling.

In the current embodiment, the primary resonating coil 18 generates an electromagnetic field for inductively transferring power to the inductive cookware 30. In alternative embodiments, the primary resonating circuit 17 may not be included in the inductive cooking power supply 10 such that the primary coil 16 transfers power to the inductive cookware 30 via an electromagnetic field.

For purposes of disclosure, the present invention is described in connection with a particular inductive cooking power supply 10 for transmitting power wirelessly to the cookware 30. The present invention, however, is well suited for use with other wireless power supply circuitry and may alternatively include essentially any wireless power supply circuitry capable of applying power to a driven primary. For example, the present invention may be incorporated into a wireless power supply system including the inductive power supply disclosed in U.S. Ser. No. 61/019,411, which is entitled “Inductive Power Supply with Duty Cycle Control” and filed Jan. 7, 2008 by Baarman; the inductive power supply of U.S. Pat. No. 7,212,414, which is entitled “Adaptive Inductive Power Supply” and issued May 1, 2007, to Baarman; the inductive power supply with communication of U.S. Pat. No. 7,522,878, which is entitled “Adaptive Inductive Power Supply with Communication” and issued Apr. 21, 2009 to Baarman; or the inductive power supply of U.S. Ser. No. 13/156,390, which is entitled “Coil Configurations for Inductive Power Transfer” and filed Jun. 9, 2011, to Baarman—all of which are incorporated herein by reference in their entirety.

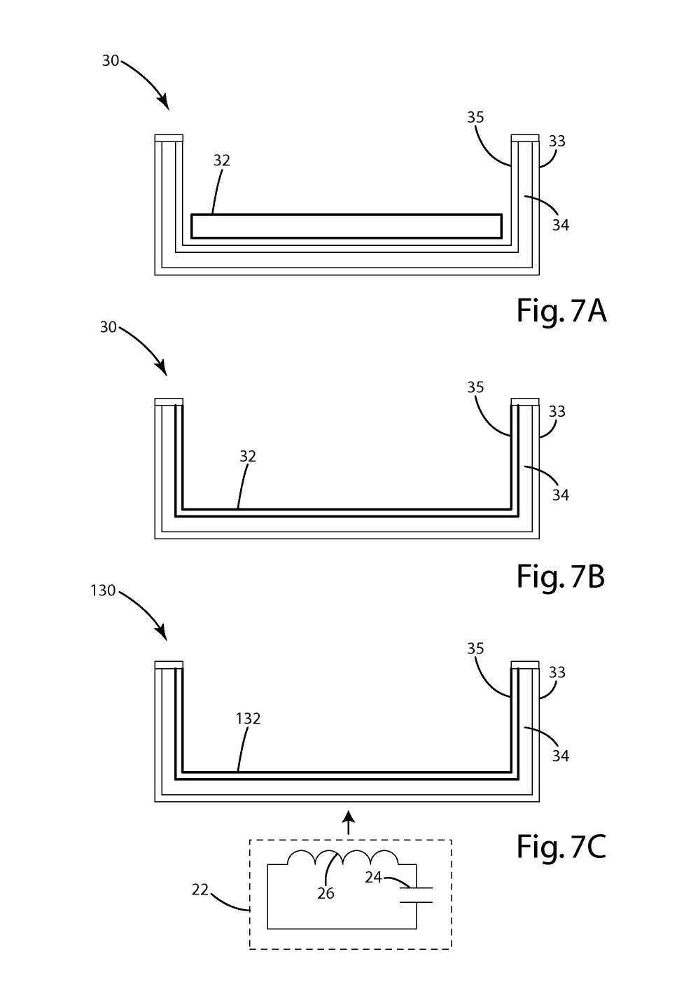

Referring to the illustrated embodiments of FIGS. 3, 4, 6a, and 7a-b, the inductive cookware 30 may be a pan or enclosure having a metal plate 32, or metal stamping, adapted to heat in the presence of an electromagnetic field. In particular, eddy currents may establish within the metal plate 32 in response to presence of an electromagnetic field. These eddy currents within the metal plate 32 produce heat for cooking items, such as food. The metal plate 32 may comprise a plate near the bottom of the inductive cookware 30, as illustrated in FIG. 7a, or, in alternative embodiments, the metal plate 32 may comprise material near the bottom, sidewalls, or both of the inductive cookware 30, such as the configuration illustrated in FIG. 7b.

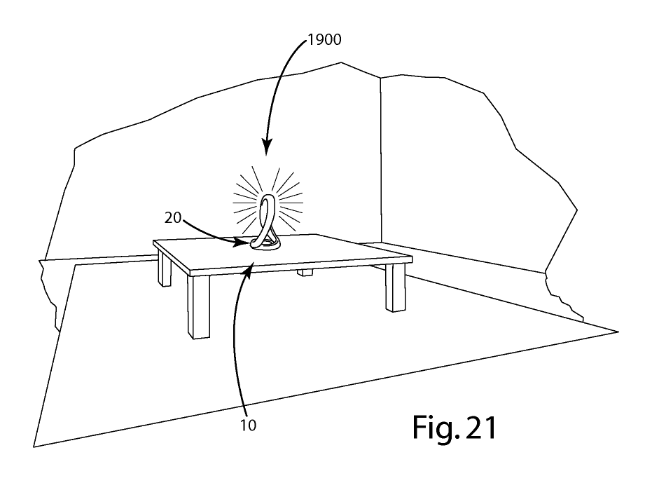

The inductive cookware 30 also may include a cooking material 35, a decorative exterior material 33, and an insulating material 34. The cooking material 35 and decorative exterior material 33 may be glass, metal, ceramic, a combination thereof, or any type of material suitable for heating an item within the inductive cookware 30. The insulating material 34 may prevent heat from transferring from the metal plate 32 or cooking material 35 to the decorative exterior material 33. In this way, the decorative exterior material 33 may have a lower temperature than that of the interior of the inductive cookware 30. For purposes of disclosure, the inductive cookware 30 is described in connection with a pan or enclosure, but the inductive cookware 30 may be any type of device adapted to receive inductive power, including a blender, a toaster, an appliance, an iron, a coffee mug, a seat warmer, a cellular phone, a portable computer, a lighting element (such as the lighting elements 1900 shown in FIGS. 19 and 21), or any other remote device, for example. The wireless power supply system described herein also is not limited to cooking applications or the kitchen—that is, the embodiments described herein also are suited for transferring power wirelessly from an inductive power supply to a remote device. In the illustrated embodiment of FIG. 20, for instance, a remote device 2000 capable of receiving wireless power is in the form of a towel or napkin warmer. The remote device 2000 includes a wireless receiver 2012 that can inductively couple with the trivet 20 or inductive cooking power supply 10, which may be a wireless power supply. The wireless receiver 2012 in the illustrated embodiment may utilize the energy received wirelessly to power a heating element that warms towels, or the wireless receiver 2012, itself, may be a heating element capable of inductively receiving power from the trivet 20 or a wireless power supply. In an alternative embodiment, the wireless receiver 2012 may provide electrical energy used to directly power remote device circuitry, such as the circuitry in a cellular phone or another remote device.

In embodiments of the inductive cookware 30 having cooking material 35 and decorative exterior material 33 formed of glass, the glass may be molded around the metal plate 32 and the insulating material 34. Likewise, embodiments having cooking material 35 and decorative exterior material 33 formed of ceramic may be fashioned around the metal plate 32 and the insulating material 34 such that they remain unexposed. Alternatively, the heating element may be exposed on one side.

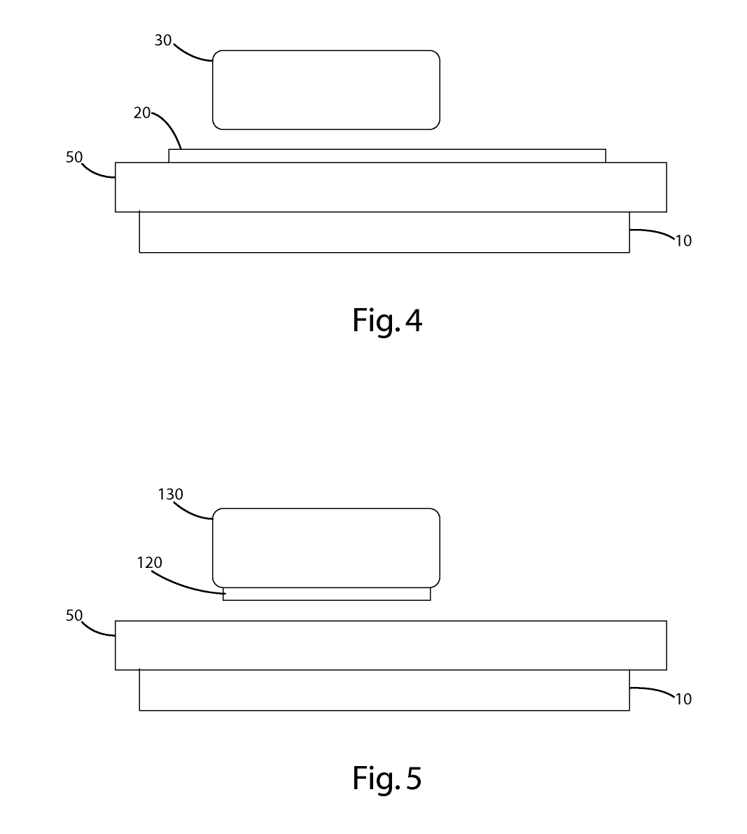

Referring again to the illustrated embodiments of the wireless power supply system of FIGS. 3 and 4, the trivet 20 may be positioned in a variety of locations to extend the range of the inductive cooking power supply 10. For example, as shown in the illustrated embodiment of FIG. 3 the trivet 20 may be disposed between the inductive cookware 30 and the inductive cooking power supply 10. Alternatively, the trivet 20 may be removably positioned within the inductive cookware 30 by, for example, placing the trivet 20 inside a cooking area of a pan.

In the illustrated embodiments of FIGS. 3 and 4, the trivet 20 includes a resonator 22 adapted to inductively couple with the primary resonating circuit 17 of the inductive cooking power supply 10 and the metal plate 32 of the inductive cookware 30. The resonator 22 may allow the metal plate 32 to receive sufficient power efficiently at greater distances than configurations having only the inductive cooking power supply 10 and the inductive cookware 30. For example, without the resonator 22, the thickness of a countertop 50 may prevent efficient wireless power transfer between the inductive cookware 30 and the inductive cooking supply 10. Placing the trivet 20 between the inductive cookware 30 and the inductive cooking power supply 10, such as by placing the trivet 20 on the countertop 50, may improve power transfer to the inductive cookware 30 through the countertop 50, including improved power transfer up to at least 4 kW. In other words, the trivet 20 may function as a range adapter and allow for efficient energy transfer without milling out the countertop 50 near the inductive cooking power supply 10 to decrease its thickness, or to decrease the distance between the inductive cooking power supply 10 and the inductive cookware 30, in order to achieve closer coupling. In this way, a countertop 50, formed of granite, wood, plastic, glass, tile, cement, or another surface material with countertop like thickness, may be fitted with a wireless power supply system as described herein. Standard thickness countertops, such as 1 inch or more thick countertops, also may be retrofitted with the wireless power supply system. For purposes of disclosure, the wireless power supply system is described in connection with countertop 50. However, the system is well suited for use with surfaces other than countertops, such as tables, desks, furniture, working surfaces, and other surfaces capable of supporting the inductive cookware 30. Additionally, in some embodiments, the trivet 20 may be used to supply power to inductive cookware that may not have been designed specifically to function with the trivet 20. Accordingly, a user may not have to purchase new inductive cookware to function with the inductive cooking power supply 10.

The resonator 22 of the trivet 20 may be disposed on or within the trivet 20, and may include a resonator coil 26 and a resonator capacitor 24 constructed similar to the primary coil 16 and primary capacitor 15 described above such that the resonator 22 has a resonant frequency. The size and shape of the resonator coil 26 may vary depending on the application. In the illustrated embodiment, the resonator coil 26 has a diameter approximately equal to the diameter of the metal plate 32 of the inductive cookware 30. Alternatively, the resonator coil 26 may be larger or smaller in diameter than the metal plate 32.

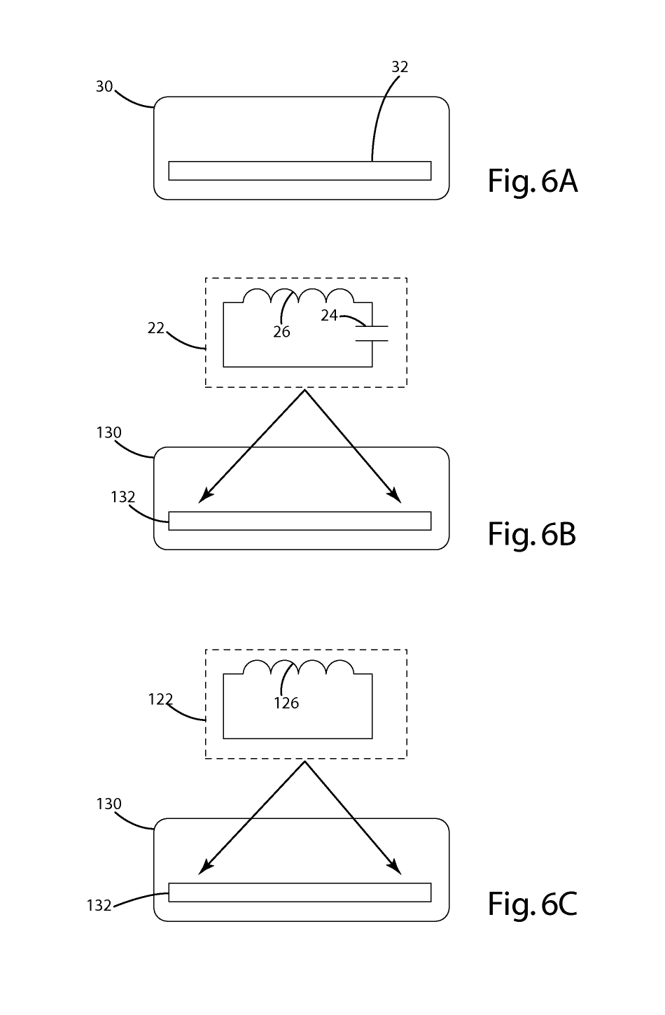

In some embodiments, the resonant frequency of the resonator 22 may be substantially similar to that of the primary resonating circuit 17, such as between 1 kHz and 10 MHz, about 100 kHz in the illustrated embodiment. In alternative embodiments, the resonator 22 may be replaced with the alternative resonator 122 of the illustrated embodiment of FIG. 6b. The alternative resonator 122 may form a resonant circuit without a resonator capacitor. For example, the resonator coil 126 may be configured to freely resonate by virtue of its internal inductance and capacitance.

The trivet 20 may be affixed to the countertop 50 using an adhesive or fastening structure. Alternatively, the trivet 20 may be portable such that it may be capable of being removably placed on the countertop 50. The trivet 20 also may include an insulating material 28 formed of a material capable of preventing or reducing heat transfer from the inductive cookware 30 to the countertop 50. The insulating material 28, which in some embodiments may operate as a thermal break, may be disposed between the trivet 20 and the countertop 50 or between the inductive cookware 30 and other components of the trivet 20. In one embodiment, the insulating material 28 may be formed of silicone material and may be disposed on the surface of the trivet 20 to support the inductive cookware 30.

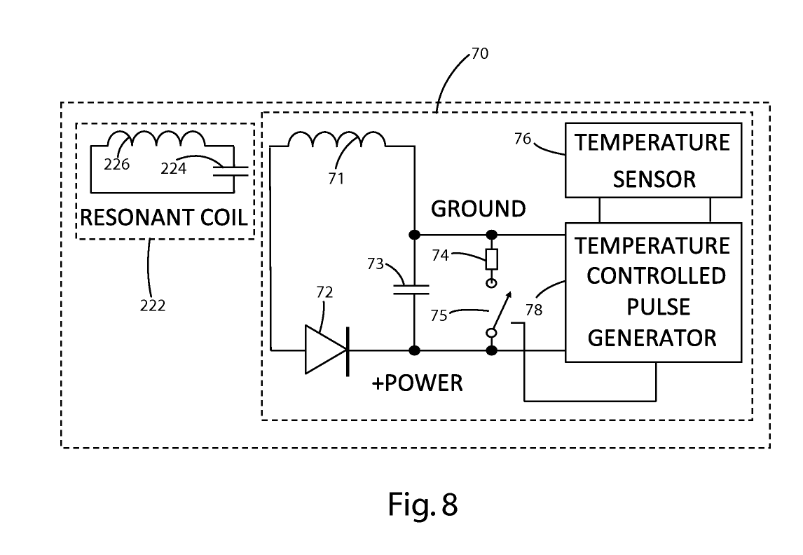

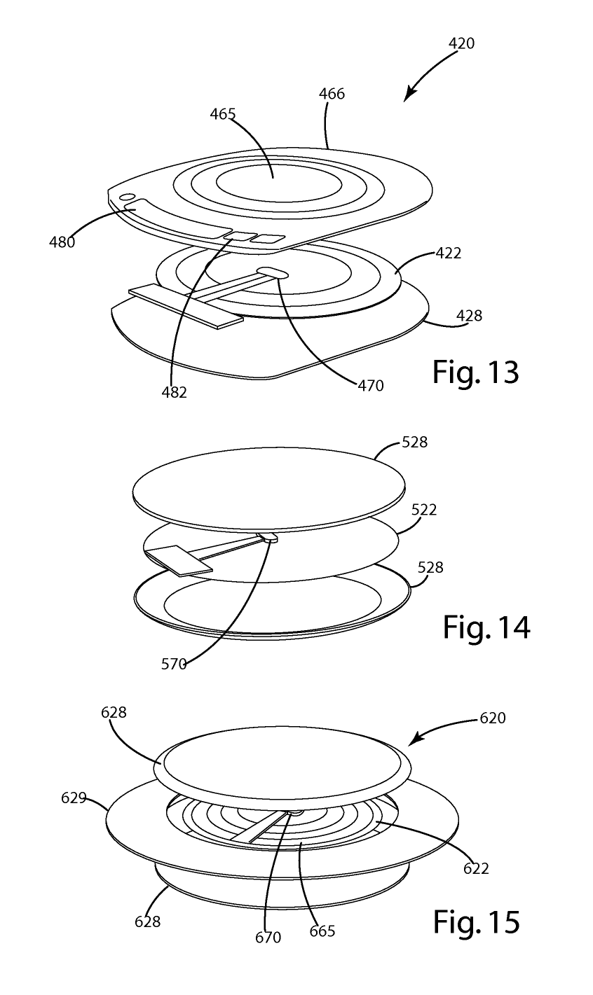

In one embodiment, the trivet 20 may additionally include temperature feedback circuitry, such as the temperature feedback circuitry 70, 470, 570, 670 shown in the illustrated embodiments of FIGS. 8 and 13-16. Referring to the various illustrated embodiments of FIGS. 13-16, in particular, the trivets 420, 520, 620, similar to the trivet 20, may include a resonator 422, 522, 622 and associated electronic circuitry and insulating material 428, 528, 628. In an alternative embodiment, the trivets 420, 520, 620 may be wireless receivers including a secondary for receiving wireless power instead of resonators 422, 522, 622. The secondary in these alternative embodiments may provide power to a heating element capable of directly heating an object such as a conventional cooking utensil or a food item.

As shown in the illustrated embodiments of FIGS. 13-16, a temperature sensor can be located within the housing of the trivet 420, 520, 620, or at or near the surface of the trivet, allowing the system to determine the temperature of the inductive cookware 30, or target device. The trivet 420, 520, 620 may communicate this temperature back to the inductive power supply 10.

Alternatively, as shown in the illustrated embodiment of FIG. 13, the trivet 420 may include a display 480, such as an LCD screen, which can display the current temperature. The trivet 420 may additionally include a user interface 482 that can allow the user to adjust the target temperature using a button and a screen interface, which may share the display 480 with the temperature feedback circuitry 470. In this embodiment, the trivet 420 can communicate to the inductive power supply 10 to control the amount of energy being coupled into the trivet 420, allowing the trivet 420 to adjust the temperature.

In addition to or alternatively, the trivet 420 may include a heating surface 466 with a heating element 465 disposed in proximity thereto. The heating element 465 maybe directly heated by the alternating magnetic field of the inductive cooking power supply 10 by generating eddy currents in the material of the heating element 465. In one embodiment, the trivet 420 may not include a resonator 422 and may receive power directly from the inductive cooking power supply 10. In another embodiment, the heating element 465 may be energized through indirect heating where energy received by the resonator 422 is used to power the heating element 465. In some embodiments, both indirect and direct heating may be used to heat the heating element 465. For instance, eddy currents generated by the inductive cooking power supply 10 and the energy received from the resonator 422 may be used in conjunction with each other to heat the heating element 465.

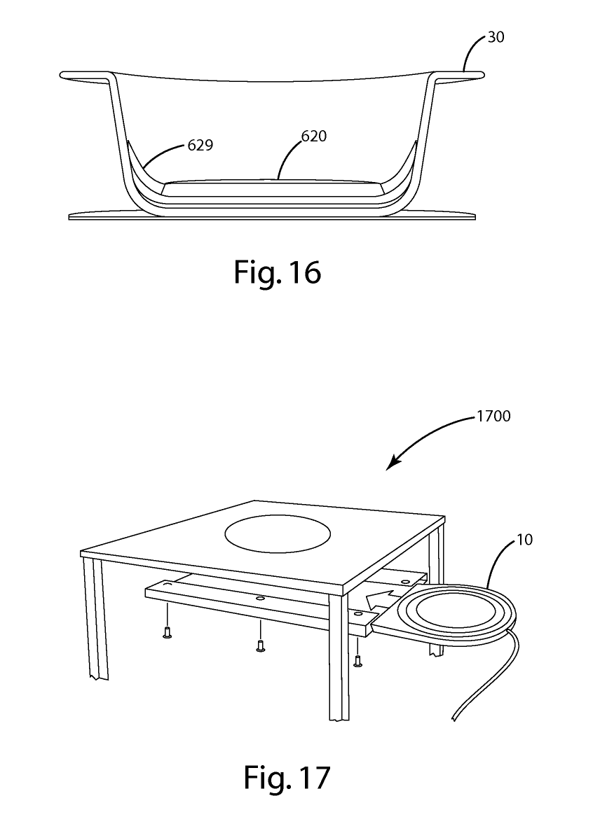

In the illustrated embodiments of FIG. 15-16, the trivet 620 may be placed within the inductive cookware 30. In this embodiment, the trivet 620 may include a silicone border 629, or other flexible material, around the perimeter of the trivet 620 that flexes when the trivet 620 is placed within a cooking vessel, such as the cookware 30 shown in FIG. 16. The silicone border 629 may fit the contour of the bottom of the cookware or cooking vessel, substantially preventing the trivet 620 from sliding around. The trivet 620 may also include a heating material 665, similar to the heating material 465 in the trivet 420, such that the trivet 620 can directly or indirectly heat food within the cookware 30. The cookware 30 in the illustrated embodiment of FIG. 16 may or may not be a conventional cooking vessel without inductive cooking capabilities.

During operation of the first embodiment of the wireless power supply system, a user may place the inductive cookware 30 on the trivet 20 and turn on the inductive cooking power supply 10 to a desired power level in order to begin heating. The primary resonating coil 18 may then begin to generate an electromagnetic field, which excites the resonator 22 to produce an electromagnetic field. In response to the electromagnetic field of the resonator 22, eddy currents establish within the metal plate 32 of the inductive cookware 32, generating heat capable of cooking food items.

In some embodiments, once the user has finished cooking the food, the user may place the inductive cookware 30 on another inductive cooking power supply 10 that closely couples to the inductive cookware 30 without a resonator 22, and keeps the food warm. Alternatively, the initial cooking of the food may be accomplished without a resonator 22 using close coupling between the inductive cooking power supply and the inductive cookware 30—e.g., the inductive cookware 30 is spatially close to a primary of the power supply—and then the user may place the inductive cookware 30 on a trivet 20 to keep the food warm using a resonator 22 and an inductive cooking power supply 10 according to one of the embodiments described above.

### II. Second Embodiment

Turning to the illustrated embodiments of FIGS. 5, 6b-c, and 7c, a second embodiment of the wireless power supply system may be similar to the embodiments described above, with several exceptions. Although the inductive cookware 130 of this second embodiment may include features in common with the inductive cookware 30 described above, the inductive cookware 130 may be coupled to a resonator 22.

In the illustrated embodiment of FIG. 5, the resonator 22 may couple to the inductive cookware 130 via a resonator attachment 120 attached to the bottom of inductive cookware 130. In this embodiment, a trivet 20, or a pad, as described above with respect to the first embodiment may not be used. The resonator attachment 120 may include many of the same features of the trivet 20 described above, but rather than being separate from the inductive cookware 30, the resonator attachment 120 may be disposed on or in the inductive cookware 30.

In the alternative embodiments illustrated in FIGS. 6b-c and 7c, the resonator 22, 122 may be disposed within the inductive cookware 130 so that the two are coupled. For instance, the resonator 22, 122 may be disposed about the perimeter of the metal plate 132 as shown in FIGS. 6b-c. More specifically, the resonator 22, 122 may be wrapped around the metal plate 132 in order to improve inductive coupling between the metal plate 132 and the resonator 22, 122. The resonator 22, 122 may be insulated from the heat of metal plate 132 by the insulating material 134 or other insulation material, such as a coating around the resonating coil 26. In further alternative embodiments, the resonator 22, 122 may be built into a layer of the inductive cookware 130 such that the insulating material 134 may be placed between the metal plate 134 and the resonator 22, 122, protecting the resonator 22, 122 from heat damage.

### III. Third Embodiment

A wireless power supply system according to a third embodiment is illustrated in FIGS. 8-10. The wireless power supply system includes an inductive cookware 230 having a cooking material 235, a decorative exterior material 233, and an insulating material 234, similar to the inductive cookware 30, 130 described above with respect to the first and second embodiments, with several exceptions. The inductive cookware 230 includes temperature feedback circuitry 70 adapted to measure the temperature of the inductive cookware 230 and provide information to the inductive cooking power supply. For example, the temperature feedback circuitry 70 may provide temperature information to the inductive cooking power supply or information indicative of the temperature of the inductive cookware 230.

Alternatively, the inductive cookware 330 may include circuitry configured to perform other functions, such as power management of the inductive cooking power supply, or transmit additional information about characteristics of the inductive cookware 330, such as the cookware's thermal characteristics for heating food. For instance, the inductive cookware 330 may include circuitry similar to that described in the cookware of U.S. Ser. No. 13/143,517, entitled “Smart Cookware” and filed Jul. 6, 2011, to Baarman et al.—which is incorporated herein by reference in its entirety.

The temperature feedback circuitry 70 includes a temperature sensor 76 for sensing the temperature of the inductive cookware 330 and a feedback controller 78. In order to power the feedback controller 78, the temperature feedback circuitry 70 also may include a resonator circuit 222, secondary coil 71, a rectifier diode 72, and a filter capacitor 73. These components may be selected, as desired, to supply appropriate power to the feedback controller 78, such as a DC power supply with an acceptable amount of ripple. More specifically, the resonator circuit 222, which may be similar to the resonator 22 described above, may be configured to receive wireless power from the inductive cooking power supply and transfer that power to the secondary coil 71. The secondary coil 71 may be configured to produce an AC output to the rectifier diode 72, which, in the illustrated embodiment, may be configured for a half-wave rectified output. The filter capacitor 73 then may smooth the output of the rectifier diode 72 to yield a DC power supply within acceptable limits for powering the feedback controller 78.

The temperature feedback circuitry 70 may also include an impedance element 74 (e.g., a resistive element, an inductive element, a capacitive element, or combinations thereof) in series with a switch 75 (e.g., a transistor) between ground and the DC output of the filter capacitor 73 of the temperature feedback circuitry 70. The feedback controller 78 may selectively control the state of the switch 75 in order to selectively apply the impedance element 74 to the DC supply. This selective application of the impedance element 74 may transmit information to the inductive cooking power supply through the inductive coupling by modulating the load of the temperature feedback circuitry 70. Modulation changes the reflected impedance through the inductive coupling between the resonator 222 and the inductive cooking power supply, which the inductive cooking power supply may sense in order to demodulate information. In this way, information may be transmitted using modulation or backscatter modulation, including amplitude modulation and frequency modulation. For purposes of disclosure, information may be transmitted to the inductive cooking power supply using temperature feedback circuitry 70, but other circuit topologies may be used to communicate information such as those described in U.S. Pat. No. 7,522,878, which is entitled “Adaptive Inductive Power Supply with Communication” and issued Apr. 21, 2009 to Baarman—which is incorporated herein by reference in its entirety. Other communication systems, such as standalone receivers and transmitters—e.g., Bluetooth—may also be used to communicate information.

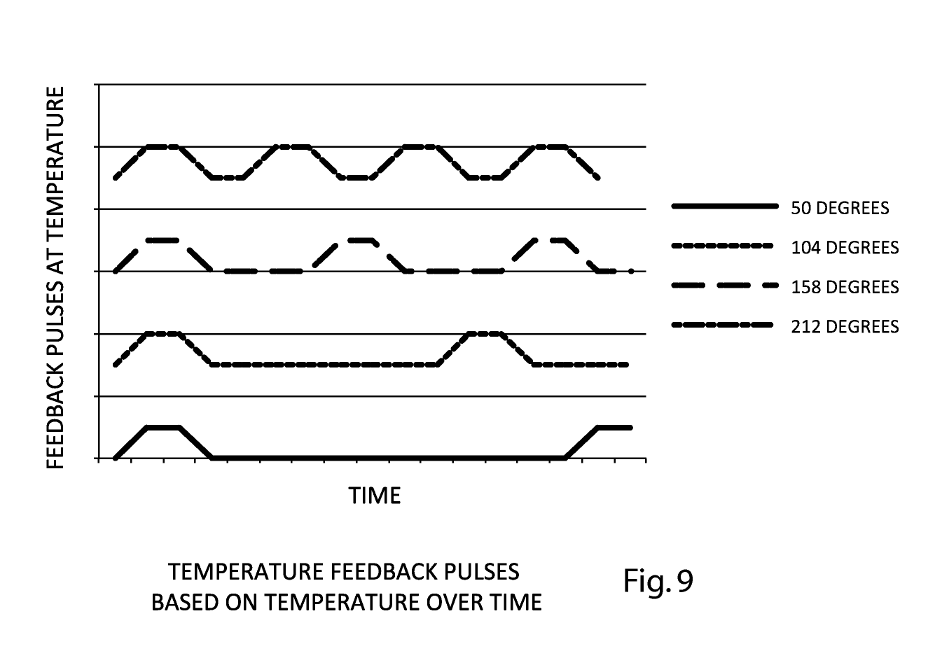

In operation, the temperature sensor 76 provides a signal indicative of the temperature of the inductive cookware 330 to the feedback controller 78, which generates a pulse having a frequency corresponding to the temperature of the inductive cookware 330. For example, the frequency of the pulse may be higher for higher temperatures and lower for lower temperatures, as illustrated in FIG. 9. The switch 75 may be selectively activated according to the pulses generated from the feedback controller 78, thereby communicating information indicative of the temperature of the inductive cookware 330 to the inductive cooking power supply 10. With this information, the inductive cooking power supply 10 may maintain or adjust its power output level according to a user-desired temperature. Alternatively, the inductive cooking power supply 10 may automatically select an appropriate temperature cycle for a given food type, and control its output accordingly based on temperature information received from the temperature feedback circuitry 70.

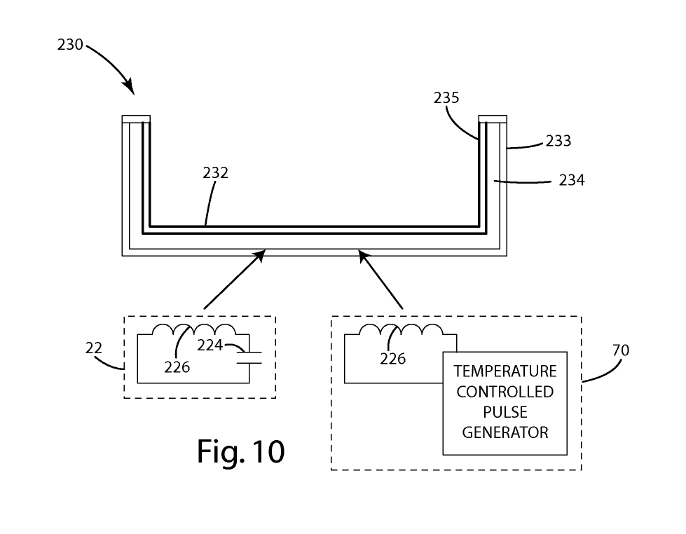

In the illustrated embodiment of FIG. 10, the inductive cookware 330 includes a resonator 22 configured to transfer power to the metal plate 232, and a resonator 222 configured to provide power to the temperature feedback circuitry 70. In alternative embodiments, the inductive cookware 330 may not include a resonator 22 such that the resonator 222 of the temperature feedback circuitry 70 may be configured to both transfer power to the metal plate 232 and the temperature feedback circuitry 70.

Portions of the temperature feedback circuitry 70 may be built into a layer of the inductive cookware 330 that is thermally insulated from the metal plate 232. For example, the insulating material 234 may be disposed between the metal plate 232 and portions of the temperature feedback circuitry 70 in order to protect it from heat damage. The temperature sensor 76 may not be thermally insulated from the metal plate 232 in order to obtain accurate temperature measurements of the inductive cookware 230. The temperature sensor 76 and a portion of the electrical conductors between the temperature sensor 76 and the feedback controller 78 may protrude through the insulating material 234. Accordingly, the temperature sensor 76 may thermally couple to the metal plate 232 or the cooking material 235 to measure the cooking temperature of the inductive cookware 230. The insulating material 234, temperature feedback circuitry 70, and resonator 22 may be disposed within the inductive cookware 230, similar to the resonator and insulating material described above.

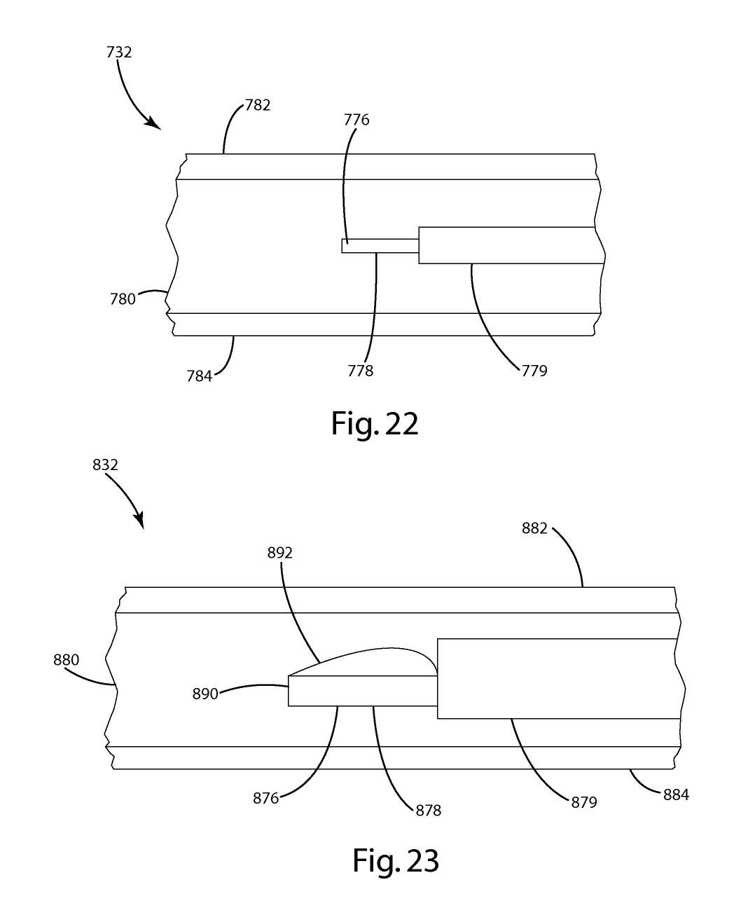

In an alternative embodiment, shown for example in FIG. 22, a thermocouple or temperature sensor 776 can be embedded into the layers of metal that produce a metal plate 732 or heating element, which may be similar to the metal plate 32, 132, 232 described herein. In this embodiment, a PZT material 778, or piezoelectric ceramic material, is molded within the layers 780, 782, 784 of the metal plate 732. In the illustrated embodiment, the PZT material 778 is approximately 0.012 inches thick and the insulation 779 is approximately 0.032 inches thick. The thickness and sizing of these components may vary as desired. The insulation 779 in this embodiment may be a glass fiber insulation, which can insulate the leads of the PZT material 778 from the metal plate 732 and may maintain temperature stability up to approximately 500° C. for the sensor and for processing.

The temperature sensor 776 in this embodiment is embedded within a base layer 780, which may be formed of one or more layers of aluminum. The base layer 780 may be joined to outer layers 782, 784, which may be formed of a variety of materials. In the illustrated embodiment, the outer layer 782 is 304 stainless steel, and the outer layer 784 is 430 magnetic stainless steel.

Layering and joining of the metal plate 732 may be accomplished using a variety of manufacturing techniques. For example, one or more temperature sensors 776 may be placed within two layers of aluminum, forming the base layer 780. This stack may be preheated to the recrystallization temperature of the aluminum, which can be slightly different depending on the grade. The layers can then be combined through pressure, resulting in diffusion bonded layers of metal.

A set of wires may connect both terminations of the PZT material 778 to electronics or circuitry within an inductive cooking device. Alternatively, a single wire connection to the PZT material 778 may be used where one termination of the PZT material 778 is connected to the body of the metal plate 732, creating a ground electrode. The electronics within the inductive cooking device may measure the capacitance between the positive termination of the PZT material 778 and the body of the metal plate 732.

In another alternative embodiment, shown for example in FIG. 23, a temperature sensor 886 may be embedded in a metal plate 832, similar to the embodiment described with respect to FIG. 22 but with several exceptions. A resistance temperature detector (RTD) based sensor 886, such as a thermistor, may be used instead of the PZT based temperature sensor 776. The temperature sensor 886 may be insulated with insulation 879 and embedded in layers 880, 882, 884 similar to the insulation 779 and layers 780, 782, 784 described in connection with the FIG. 22 embodiment. In this embodiment, the RTD material 878 of the temperature sensor 876 may be a thin film platinum RTD having a ceramic substrate 890 and a glass coated platinum element 892. It should be understood that the present invention is not limited to a platinum RTD sensor and that any RTD based sensor, or any temperature sensor, may be used.

In the illustrated embodiment of FIG. 23, the RTD material 878 is approximately 0.052 inches thick at its widest point across the ceramic substrate 890 and glass coated platinum element 892. The length of the temperature sensor 876 from the insulation 879 to the tip of the temperature sensor 876 is approximately 0.132 inches. The dimensions and sizing of the components and features of the temperature sensor 776 may vary as desired.

The temperature sensor 876 in this embodiment is embedded within a base layer 880, which may be formed of one or more layers of aluminum. The base layer 880 may be joined to outer layer 882 and outer layer 884, which, in the illustrated embodiment, are 304 stainless steel and 430 magnetic stainless steel, respectively. The present invention is not limited to these material selections; rather, it should be understood that the listed material selections are examples, and that any material type suitable for the metal plate 832 in an inductive cookware may be used.

### IV. Fourth Embodiment

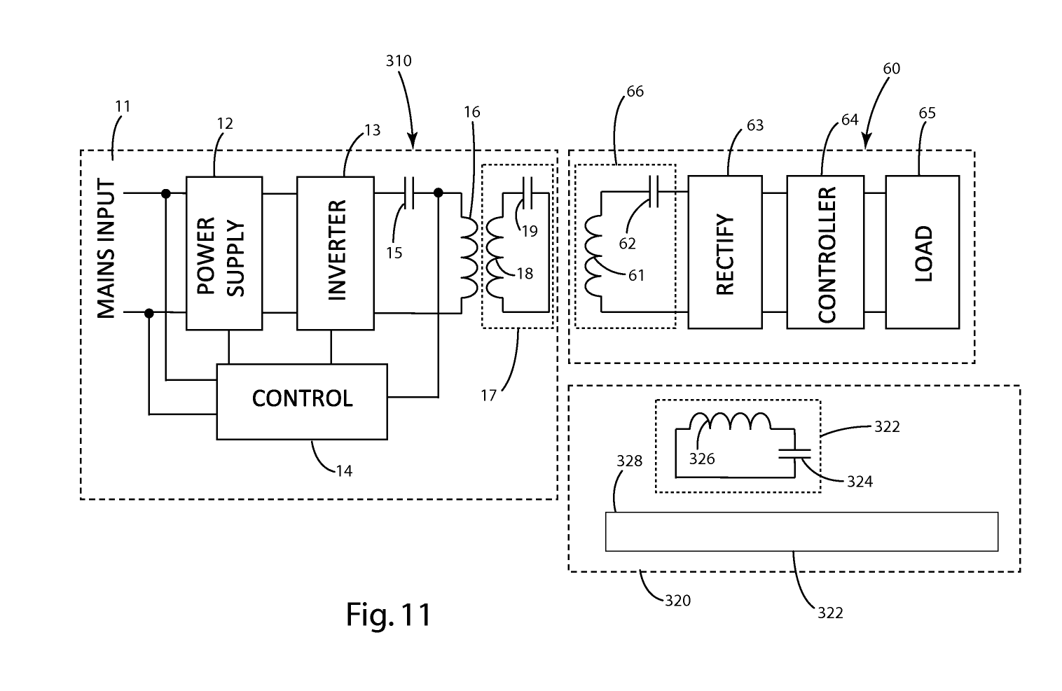

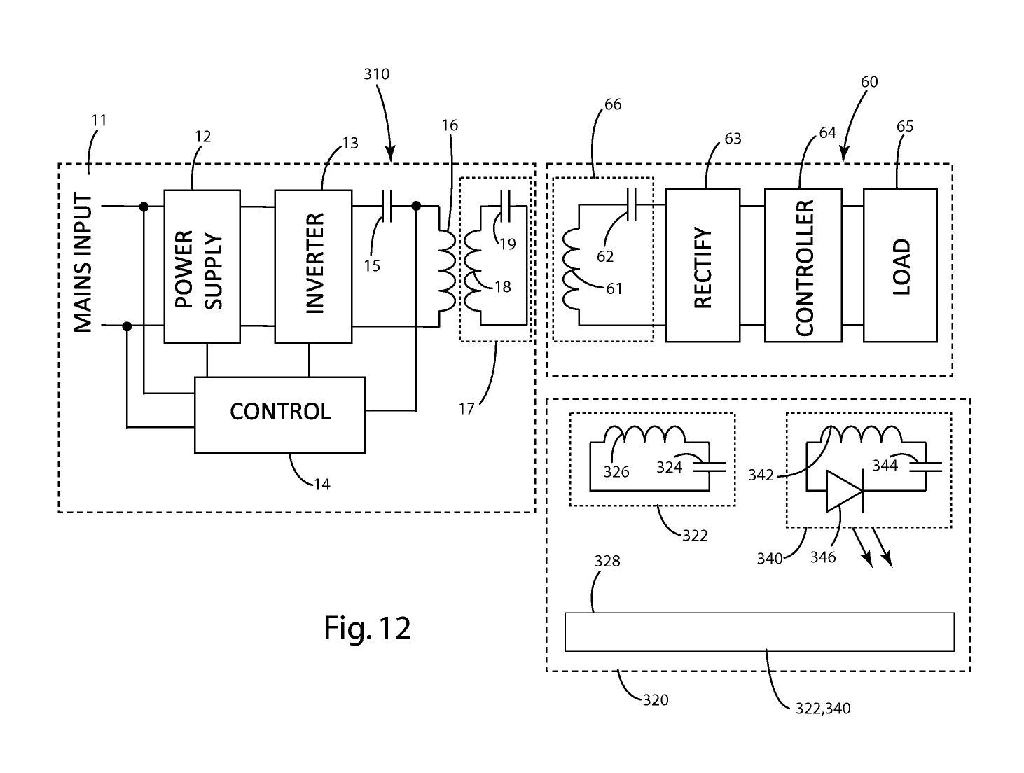

FIGS. 11-12 illustrate a fourth embodiment of a wireless power supply system. The wireless power supply 310 and pad 320 are similar to the inductive cooking power supply 10 and trivet 20, respectively described above, with several exceptions. As mentioned above, the inductive cooking power supply 10 is not limited to the kitchen or heating metal in inductive cookware. The inductive cooking power supply 10, 310 may be configured to power a device 60, including inductive cookware, appliances, portable devices, cellular phones, or other devices. The pad 320 in the illustrated embodiment also may function as a range adapter, similar to the trivet 20 described above, to improve power transfer to the portable device 60 from the wireless power supply 310 over varying distances.

The device 60 may include a secondary 61, a secondary resonant capacitor 62, a rectifier 63, a DC/DC converter 64, and a load 65. The secondary 61 and the secondary resonant capacitor 62 may form a secondary tank circuit 66, and may have a construction similar to that of the primary coil 16 and primary capacitor 15 described above.

The rectifier 63 may include circuitry for converting a signal received from the secondary tank circuit 66 into a rectified output for the DC/DC converter 64. For example, the rectifier 63 may transform an AC signal received from the secondary tank circuit 66 into a full wave rectified output. In alternative embodiments, the rectifier 63 may also include circuitry for smoothing the rectified output into a substantially DC output to the DC/DC converter 64. In the current embodiment, the DC/DC converter 64 may include circuitry for receiving a rectified input and providing power to the load 65. The DC/DC converter 64 may detect and regulate power to the load 65 so that the load 65 may receive an appropriate amount of energy. The load 65 may include any type of electrical impedance, such as device circuitry, a controller, a battery, a motor, or combinations thereof. In alternative embodiments, the load 65 may be externally connected to the device 60 so that the device 60 may be separable from the load 65, and in further alternative embodiments, the DC/DC converter 64 may be omitted and the load 65 may be connected directly to the rectifier 63.

In the current embodiment, a controller (not shown) may wirelessly communicate with the wireless power supply 310 using various techniques. For example, the controller may use transceiver circuitry (not shown) to wirelessly communicate with the wireless power supply 310 via IEEE 802.11, Bluetooth, or IrDA protocols. As another example, the controller may be capable of wirelessly communicating over the secondary tank circuit 66 using modulation techniques, as described above.

The device 60 and the wireless power supply 310 may exchange information such as operational parameters. Operational parameters may include circuit measurements, circuit characteristics, or device identification information. In alternative embodiments, the device 60 and the wireless power supply 310 may not communicate with each other. In these embodiments, the wireless power supply 310 may detect operational parameters of the device 60 by identifying the reflected impedance of the device 60. In yet another alternative embodiment, the wireless power supply 310 may communicate with another device connected to the device 60 to transmit and receive operational parameters.

In the illustrated embodiment of FIG. 11, the pad 320 includes a resonator 322 and an insulating material 328 similar to the resonator 22 and insulating material 28 as described above. The pad 320 also may be affixed to a surface or portable as mentioned in other embodiments herein. The pad 320, as illustrated in the alternative embodiment of FIG. 12, may also include a power indicator 340 having an LED 346 that lights up in response to presence of an electromagnetic field, providing a visual indication to a user that power may be available. The power indicator 340 may include a power secondary 342 and a power resonant capacitor 344 configured to receive wireless power from the electromagnetic field and energize the LED 346. In further alternative embodiments, the power secondary 342 and power resonant capacitor 344 may not be present, and the LED 346 of the power indicator 340 may be connected to other circuitry of the pad 320, such as the resonator 322.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A wireless power device comprising:
a pad adapted to be removably placed between a device and a primary of an inductive power supply;
a resonator coupled to the pad, the resonator adapted inductively transfer energy from said primary to the device, whereby the resonator extends the range over which the device receives wireless power from the inductive power supply.

2. The wireless power device of claim 1 wherein the device is an inductive cookware, and wherein the inductive cookware includes metal adapted to heat in the presence of an electromagnetic field generated from the inductive power supply.

3. An inductive cooking system for heating metal of an inductive cookware comprising:
an inductive cooking power supply having a primary, the inductive cooking power supply adapted to produce an electromagnetic field;
a resonator adapted to inductively transfer energy from the primary to the metal such that the metal of the inductive cookware heats in response to the electromagnetic field being produced by the inductive cooking power supply.

4. The inductive cooking system of claim 3 further including a pad adapted to be placed between the inductive cooking power supply and the inductive cookware, and wherein the pad is coupled to the resonator.

5. The inductive cooking system of claim 4 wherein the pad is a portable trivet.

6. The inductive cooking system of claim 4 wherein the pad is positioned on a surface of a countertop, and wherein the inductive cooking power supply is positioned on an opposite surface of the countertop.

7. The inductive cooking system of claim 6 wherein the pad is affixed to the surface of the countertop.

8. The inductive cooking device as claimed in claim 1 wherein the pad includes an insulator adapted to inhibit heat transfer from the inductive cookware through the pad.

9. The inductive cooking device claim 1 wherein the resonator is disposed within the pad.

10. The inductive cooking system of claim 4 wherein the resonator is coupled to the inductive cookware.

11. The inductive cooking system of claim 4 wherein the inductive cookware includes a temperature sensor embedded within layers of metal.

12. The inductive cooking system of claim 11 wherein the temperature sensor is a PZT sensor.

13. The inductive cooking system of claim 11 wherein the temperature sensor is an RTD sensor.

14. The inductive cooking system as claimed in claim 4 wherein the pad includes an insulator adapted to inhibit heat transfer from the inductive cookware through the pad.

15. The inductive cooking system as claimed in claim 4 wherein the resonator is disposed within the pad.
